(19) United States
(12) Patent Application Publication
(10) Pub. No.: US 2019/0264883 A1
(43) Pub. Date: Aug. 29, 2019

(54) Candle Lamp

(71) Applicants: Li Xin Thomas LI, Hong Kong (CN); Yi YANG, Changsha (CN)

(72) Inventors: Li Xin Thomas LI, Hong Kong (CN); Yi YANG, Changsha (CN)

(21) Appl. No.: 16/283,575

(22) Filed: Feb. 22, 2019

(30) Foreign Application Priority Data
Feb. 24, 2018 (CN) 201820266250.3

(51) Int. Cl. F21S 10/04; F21S 6/00; F21V 35/00

(52) U.S. Cl. CPC F21S 10/043; F21V 35/00; F21S 6/001

(57) ABSTRACT

A candle lamp includes a lamp holder having a storage compartment, the lamp holder has an opening at a top portion. The candle lamp further has a power supply provided inside the lamp holder, a control panel electrically connected to the power supply, a plurality of light sources electrically connected to the control panel. The candle lamp also has a plurality of light guides which generate a continuous line of light toward the opening. The candle lamp further has a plurality of light guides, each of the light guides optically communicate with the corresponding light source so that the continuous line of light propagate toward the corresponding light guide and the line of light is refracted outwardly emitting a glowing light for the candle lamp.

### BACKGROUND OF THE PRESENT INVENTION

### Field of Invention

The patent relates to the technical field of lamp, in particular to a lamp which resembles a candle lamp.

### Description of Related Arts

The candle lamp utilizes an electrical light source to mimic the outlook of a candle light and the candle flame appearance. The candle lamp provides a natural, warm, yellowish light source which looks the candle light flame. At the same time, it can be safely used without any fire hazard concern.

There are primary two kinds of conventional candle lamps in the market. The first kind has a fixed shape flame appearance. By changing the supply current to the light source, it can change the dynamic of the flame appearance. However, since the shape is fixed, the overall flame appearance may seem dull and unrealistic. The second kind of conventional candle lamp utilizes mechanism to cause the flame to swing to enhance the dynamic of the flame appearance. This kind of candle lamp involves a relatively complicated mechanical structure and the efficiency is low as well. The flame appearance produced by both kinds of conventional lamps mentioned above are dull as they lack adjustment to control the flame appearance rendering a realistic look.

### SUMMARY OF THE PRESENT INVENTION

The present invention provides a candle lamp which realistically mimics the candle light flame appearance with a simple structure and high operating efficiency.

In one aspect of the present invention, it provides a candle lamp, comprising:

a lamp holder having a storage compartment and an opening formed at a top portion of the lamp holder;

a power supply supported by the lamp holder in the storage compartment;

a control panel supported by the lamp holder in the storage compartment electrically connected to the power supply;

a plurality of light sources electrically connected to the control panel supported by the lamp holder in the storage compartment, each of the light sources generating a continuous line of light toward the opening; and

a plurality of light guides, each of the light guides optically communicating with the corresponding light source so that when the corresponding continuous line of light propagate toward the corresponding light guide, the continuous line of light is arranged to penetrate through the light guide and to be refracted outwardly with respect to the lamp holder for emitting a glowing light for the candle lamp.

This summary presented above is provided merely to introduce certain concepts and not to identify any key or essential features of the claimed subject matter.

### BRIEF DESCRIPTION OF THE DRAWINGS

FIG. 1 is a structural diagram of the candle lamp of the present invention.

FIG. 2 is a side view of the light guides according to the first embodiment of the present invention.

FIG. 3 is top view of the light sources according to the first embodiment of the present invention.

FIG. 4 is a side view of the combined light guides and light sources according to the first embodiment of the present invention.

FIG. 5 is a side view of the light guides according to the second embodiment of the present invention.

FIG. 6 is top view of the light sources according to the second embodiment of the present invention.

FIG. 7 is a side view of the combined light guides and light sources according to the second embodiment of the present invention.

FIG. 8 is a side view of the light guides according to the second embodiment of the present invention.

FIG. 9 is top view of the light sources according to the second embodiment of the present invention.

FIG. 10 is a side view of the combined light guides and light sources according to the second embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

In the description of this patent, it is important to note that, the orientation or position relationship of the terms “Up”, “Under”, “Inside”, “Outside”, etc., is based on the orientation or position relationship shown in the figures, or the position or orientation relationship that is routinely placed when the patented product is used. Just only to describe this patent and simplify description, rather than indicating or implying that the device or element referred to must have a particular orientation and be constructed and operated in a particular orientation, therefore, it cannot be understood as a limitation of this patent.

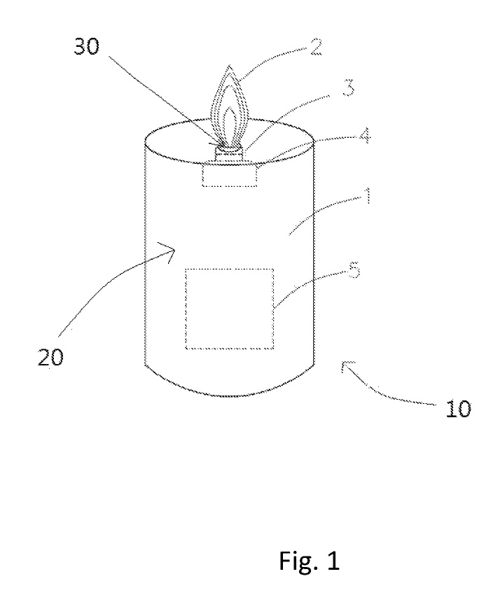

Referring to FIG. 1 of the drawings, a structural diagram of a candle lamp 10 of the present invention is illustrated. Broadly, the candle lamp 10 comprises a lamp holder 1, a plurality of light guides 2, a plurality of light sources 3, a control panel 4, and a power supply 5. The plurality of light guides 2 are arranged in layer configuration with respect to each other forming a candle light appearance. Each of the plurality of light guides 2 optically commutes with the corresponding light source 3. An output end of the control panel 4 is electrically connected to the plurality of light sources 3.

The candle lamp 10 of the present invention mimics the flame appearance of a candle light by using the layered plurality of light guides 2. Each of the light guide 2 optically communicates with the corresponding light source 3. By controlling the plurality of light sources 3 through the control panel 4, a natural, realistic candle light flame appearance can be achieved. The candle lamp 10 of the present invention has simple structures which can reduces the manufacturing cost. At the same time, the design can enhance the usage efficiency and prolong the product's life.

### First Embodiment of the Present Invention

Specifically, the lamp holder 1 is a cylindrical body having a storage compartment 20 inside. The lamp holder 1 has an opening 30 formed at a top portion. The plurality of light sources 3, the control panel 4, and the power supply 5 are supported by the lamp holder 1 in the storage compartment 20 of the lamp holder 1. The plurality of light guides 2 are placed on top of the opening 30 of the lamp holder 1 such that the plurality of light guides 2 erect from the opening 30 of the top portion of the lamp holder 1. A bottom portion of the light guide 2 is directly placed on top of the light source 3 through the opening of the lamp holder 1. The plurality of light guides 2 can be glued onto the plurality of light sources 3 directly. The plurality of light sources 3 are soldered onto the control panel 4. The control panel 4 electrically connects with the power supply 5 which provides the electrical power for the plurality of light sources 3 and the control panel 4. The power supply 5 may be a fixed AC power supply, a dry cell battery or a rechargeable battery.

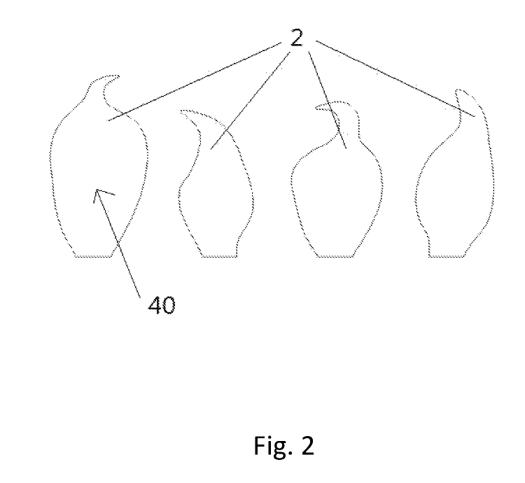

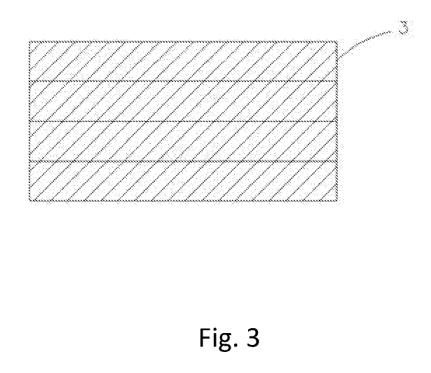

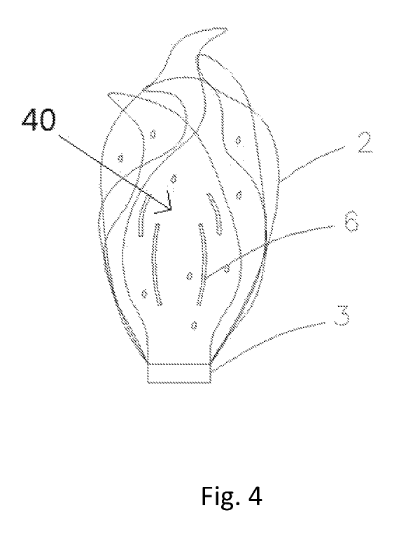

Referring to FIG. 2 to FIG. 4 of the drawings, the first embodiment of the present invention is illustrated. FIG. 2 of the drawings is a side view of the plurality of light guides 2 according to the first embodiment of the present invention in a separated manner for illustration purpose. FIG. 3 of the drawings is a top view of the plurality of light sources 3 according to the first embodiment of the present invention. FIG. 4 of the drawings is a side view of the combined light guides 2 and light sources 3 according to the first embodiment of the present invention. According to the first embodiment of the present invention, the plurality of light guides 2 are a flat piece of optical conductor which may come in different kinds of shape and contour to mimic the outlook of the flame appearance. Specifically, the shape has a narrow pointy tip at the top portion, a wide body at the middle portion, and a narrow body near the lower portion. The plurality of light guides 2 further comprise a display surface 40 which is the surface that shows the flame appearance. The plurality of light guides 2 have relatively similar sizes in its height and width. Specifically, the bottom portion of the plurality of light guides 2 have the same width. According to the first embodiment of the present invention, the layer configuration of the plurality of light guides 2 is setup in a way that the plurality of light guides 2 are placed horizontally next to each another forming a flame appearance.

Each of the plurality of light guides 2 has a bottom portion optically communicates with the corresponding light source 3. Therefore, according to the first embodiment of the present invention, the plurality of light sources 3 also have the same width as the bottom portion of the light guides 2 so that each light source 3 can fittedly match with its corresponding light guide 2. The plurality of light guides 2 are transparent body capable for conducting optical sources. Preferably, light guides 2 are made of acrylic material for its optical transmitting property. When the light source 3 generates a continuous line of light toward the opening 30, the continuous line of light propagates toward the corresponding light guide 2. The continuous line of light is arranged to penetrate through the light guide 2 and to be refracted outwardly with respect to the lamp holder 1 for emitting a glowing light for the candle lamp 10. The plurality of light sources 3 may be and are not limited to compact fluorescent lamp, fluorescent light, or LED lights. Preferably, the plurality of light sources 3 are LED lights.

In order to produce a realistic and dynamic flame appearance, each individual light source 3 provides the continuous line of light with different wavelengths and color temperatures. Therefore, the different wavelengths and color temperatures light combination may render a more realistic and dynamic candle light flame appearance through the display from the layer configuration of the plurality of light guides 2.

Referring to FIG. 4 of the drawings, a side view of the combined light guides 2 and light sources 3 according to the first embodiment of the present invention is illustrated. Each of the light guide 2 further comprises optical veins 6 provided on the display surface 40. The optical veins 6 may be a combination of an engraved indentation or a protruded surface. Furthermore, the engraved indentation or the protruded surface may be in strip or point shape. The optical veins 6 are placed on the display surface 40 of the light guides 2 to conduct or to refract the continuous line of light emitted from the light source 3 in order to produce a more three-dimensional candle light flame appearance. Specifically, optical veins 6 are only provided at an upper portion and a middle portion of the display surface 40. Since the continuous line of light are only refracted outwardly when they arrive at the middle portion or upper portion of the display surface 40, the bottom portion of the display surface 40 will appear not to be emitting light. Therefore, the candle light flame appearance of the candle lamp 10 of the present invention will appear to be suspended which is similar to the real candle light flame.

In addition, in order to prevent loss of light from the plurality of light sources 3, the surroundings of the light source 3 are painted in black color. The top area of the plurality of light sources 3 is transparent which allows the continuous line of light to propagate toward the corresponding light guide 2. In this way, the line of continuous light directly penetrates through the light guide 2 and is different from the setup of a traditional light bulb generating a point source of light with a light cover covering it.

During the operation of the candle lamp 10, the control panel 4 may adjust the magnitude and the timing of the current supplied to the plurality of light sources 3 in order to make the candle lamp flame has different color and patterns. The layer configuration of the plurality of light guides 2 and optical veins 6 may create an illusion to the human eyes that the flame is dynamic and realistic.

### Second Embodiment of the Present Invention

Specifically, the lamp holder 1 is a cylindrical body having a storage compartment 20 inside. The lamp holder 1 has an opening 30 formed at a top portion. The plurality of light sources 3, the control panel 4, and the power supply 5 are supported by the lamp holder 1 in the storage compartment 20 of the lamp holder 1. The plurality of light guides 2 are placed on top of the opening 30 of the lamp holder 1 such that the plurality of light guides 2 erect from the opening 30 of the top portion of the lamp holder 1. A bottom portion of the light guide 2 is directly placed on top of the light source 3 through the opening of the lamp holder 1. The plurality of light guides 2 can be glued onto the plurality of light sources 3 directly. The plurality of light sources 3 are soldered onto the control panel 4. The control panel 4 electrically connects with the power supply 5 which provides the electrical power for the plurality of light sources 3 and the control panel 4. The power supply 5 may be a fixed AC power supply, a dry cell battery or a rechargeable battery.

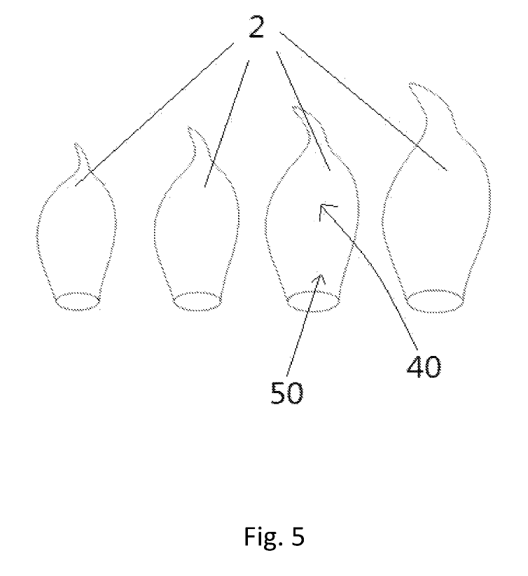

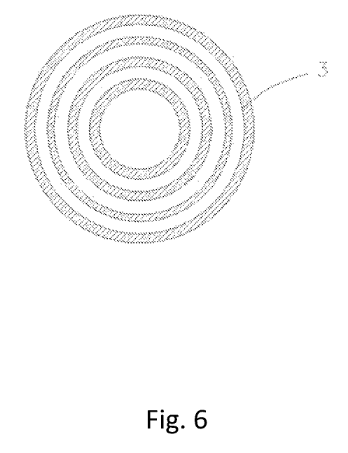

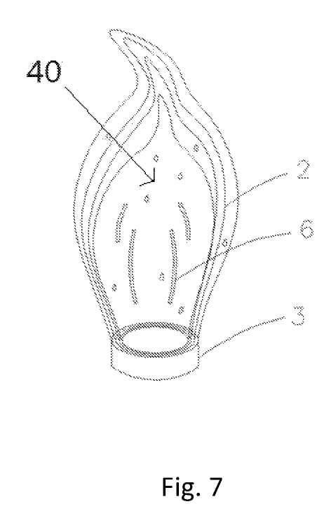

Referring to FIG. 5 to FIG. 7 of the drawings, the second embodiment of the present invention is illustrated. FIG. 5 of the drawings is a side view of the plurality of light guides 2 according to the second embodiment of the present invention in a separated manner for illustration purpose. FIG. 6 of the drawings is a top view of the plurality of light sources 3 according to the second embodiment of the present invention. FIG. 7 of the drawings is a side view of the combined light guides 2 and light sources 3 according to the second embodiment of the present invention. According to the second embodiment of the present invention, the plurality of light guides 2 are molded into cover shape optical conductors which have the same shape and contour to mimic the outlook of the flame appearance. Specifically, the cover shape has a narrow pointy tip at the top portion, a wide body at the middle portion, and a narrow body near the lower portion. The plurality of light guides 2 further comprise a display surface 40 which is the surface that shows the flame contour. The display surface 40 forms a cavity 50 inside the light guide 2. The plurality of light guides 2 are different in sizes and they can be stacked onto each other concentrically from smallest to largest forming a flame appearance erected on the top portion of the lamp holder 1 to form the candle lamp 10.

Each of the plurality of light guides 2 has a bottom portion optically communicates with the corresponding light source 3. Therefore, according to the second embodiment of the present invention, the plurality of light sources 3 also share the same cross-sectional area of the bottom portion of the light guides 2 so that each light source 3 can fittedly match with its corresponding light guide 2. Referring to FIG. 6 of the drawings, the plurality of light sources 3 are spacedly layered concentrically. The plurality of light guides 2 are transparent body capable for conducting optical sources. Preferably, light guides 2 are made of acrylic material for its optical transmitting property. When the light source 3 generates a continuous line of light toward the opening 30, the continuous line of light propagates toward the corresponding light guide 2. The continuous line of light is arranged to penetrate through the light guide 2 and to be refracted outwardly with respect to the lamp holder 1 for emitting a glowing light for the candle lamp 10. The plurality of light sources 3 may be and are not limited to compact fluorescent lamp, fluorescent light, or LED lights. Preferably, the plurality of light sources 3 are LED lights

In order to produce a realistic and dynamic flame appearance, each individual light source 3 provides a continuous line of light with different wavelengths and color temperatures. Therefore, the different wavelengths and color temperatures light combination may render a more realistic and dynamic candle light flame appearance through the display from the layer configuration of the plurality of light guides 2.

Referring to FIG. 7 of the drawings, a side view of the combined light guides 2 and light sources 3 according to the second embodiment of the present invention is illustrated. Each of the light guide 2 further comprises optical veins 6 provided on the display surface 40. The optical veins 6 may be a combination of an engraved indentation or a protruded surface. Furthermore, the engraved indentation or the protruded surface may be in strip or point shape. The optical veins 6 are placed on the display surface 40 of the light guides 2 to conduct or to refract the continuous line of light emitted from the light source 3 in order to produce a more three-dimensional candle light flame appearance. Specifically, optical veins 6 are only provided at an upper portion and a middle portion of the display surface 40. Since the continuous line of light are only refracted outwardly when they arrive at the middle portion or upper portion of the display surface 40, the bottom portion of the display surface 40 will appear not to be emitting light. Therefore, the candle light flame appearance of the candle lamp 10 of the present invention will appear to be suspended which is similar to the real candle light flame.

In addition, in order to prevent loss of light from the plurality of light sources 3, the surroundings of the light source 3 are painted in black color. The top area of the plurality of light sources 3 is transparent which allows the continuous line of light to propagate toward the corresponding light guide 2. In this way, the line of continuous light directly penetrates through the light guide 2 and is different from the setup of a traditional light bulb generating a point source of light with a light cover covering it.

During the operation of the candle lamp 10, the control panel 4 may adjust the magnitude and the timing of the current supplied to the plurality of light sources 3 in order to make the candle lamp flame has different color and patterns. The layer configuration of the plurality of light guides 2 and optical veins 6 may create an illusion to the human eyes that the flame is dynamic and realistic.

### Third Embodiment of the Present Invention

Specifically, the lamp holder 1 is a cylindrical body having a storage compartment 20 inside. The lamp holder 1 has an opening 30 formed at a top portion. The plurality of light sources 3, the control panel 4, and the power supply 5 are supported by the lamp holder 1 in the storage compartment 20 of the lamp holder 1. The plurality of light guides 2 are placed on top of the opening 30 of the lamp holder 1 such that the plurality of light guides 2 erect from the opening 30 of the top portion of the lamp holder 1. A bottom portion of the light guide 2 is directly placed on top of the light source 3 through the opening of the lamp holder 1. The plurality of light guides 2 can be glued onto the plurality of light sources 3 directly. The plurality of light sources 3 are soldered onto the control panel 4. The control panel 4 electrically connects with the power supply 5 which provides the electrical power for the plurality of light sources 3 and the control panel 4. The power supply 5 may be a fixed AC power supply, a dry cell battery or a rechargeable battery.

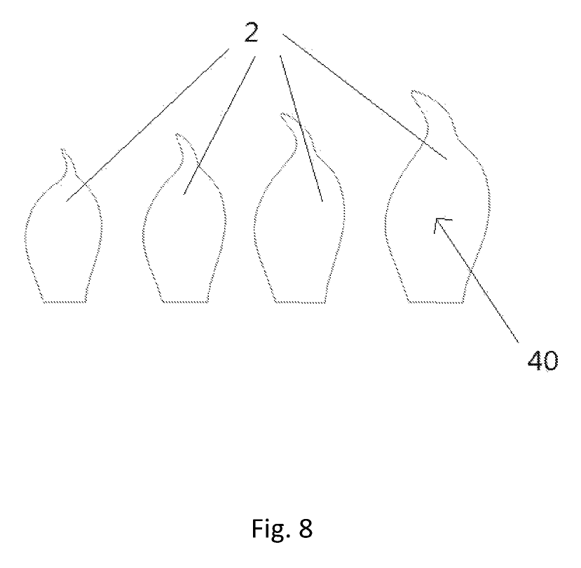

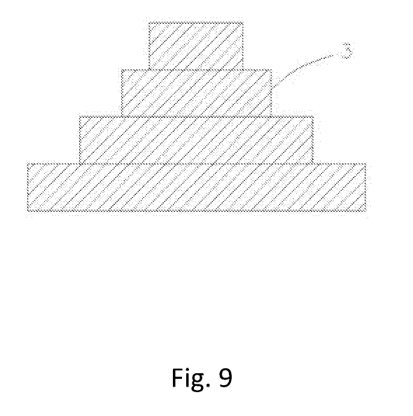

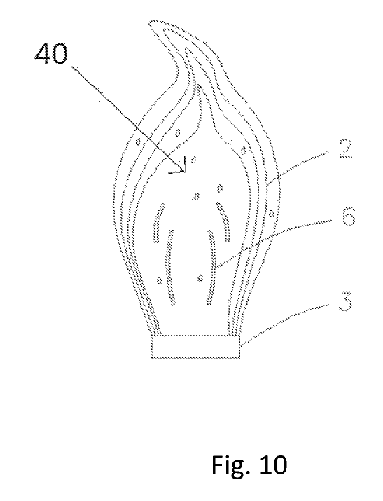

Referring to FIG. 8 to FIG. 10 of the drawings, the third embodiment of the present invention is illustrated. FIG. 8 of the drawings is a side view of the plurality of light guides 2 according to the third embodiment of the present invention in a separated manner for illustration purpose. FIG. 9 of the drawings is a top view of the plurality of light sources 3 according to the third embodiment of the present invention. FIG. 10 of the drawings is a side view of the combined light guides 2 and light sources 3 according to the third embodiment of the present invention. According to the third embodiment of the present invention, the plurality of light guides 2 are a flat piece of optical conductor which have the same shape and contour to mimic the outlook of the flame appearance. Specifically, the shape has a narrow pointy tip at a top portion, a wide body at the middle portion, and a narrow body near the lower portion. The plurality of light guides 2 further comprise a display surface 40 which is the surface that shows the flame appearance. The plurality of light guides 2 are different in sizes. Specifically, different sizes mimic the outlook of a flame from a small to large scale as show in FIG. 8 of the drawings. According to the third embodiment of the present invention, the layer configuration of the plurality of light guides 2 is setup in a way that the plurality of light guides 2 are placed horizontally next to each another forming a flame appearance.

Each of the plurality of light guides 2 has a bottom portion optically communicates with the corresponding light source 3. Therefore, according to the third embodiment of the present invention, each of the plurality of light sources 3 also has the same width as the corresponding bottom portion of the light guides 2 so that each light source 3 can fittedly match with its corresponding light guide 2. The plurality of light guides 2 are transparent body capable for conducting optical sources. Preferably, light guides 2 are made of acrylic material for its optical transmitting property. When the light source 3 generates a continuous line of light toward the opening 30, the continuous line of light propagates toward the corresponding light guide 2. The continuous line of light is arranged to penetrate through the light guide 2 and to be refracted outwardly with respect to the lamp holder 1 for emitting a glowing light for the candle lamp 10. The plurality of light sources 3 may be and are not limited to compact fluorescent lamp, fluorescent light, or LED lights. Preferably, the plurality of light sources 3 are LED lights

In order to produce a realistic and dynamic flame appearance, each individual light source 3 provides the continuous line of light with different wavelengths and color temperatures. Therefore, the different wavelengths and color temperatures light combination may render a more realistic and dynamic candle light flame appearance through the display from the layer configuration of the plurality of light guides 2.

Referring to FIG. 10 of the drawings, a side view of the combined light guides 2 and light sources 3 according to the third embodiment of the present invention is illustrated. Each of the light guide 2 further comprises optical veins 6 provided on the display surface 40. The optical veins 6 may be a combination of an engraved indentation or a protruded surface. Furthermore, the engraved indentation or the protruded surface may be in strip or point shape. The optical veins 6 are placed on the display surface 40 of the light guides 2 to conduct or to refract the continuous line of light emitted from the light source 3 in order to produce a more three-dimensional candle light flame appearance. Specifically, optical veins 6 are only provided at an upper portion and a middle portion of the display surface 40. Since the continuous line of light are only refracted outwardly when they arrive at the middle portion or upper portion of the display surface 40, the bottom portion of the display surface 40 will appear not to be emitting light. Therefore, the candle light flame appearance of the candle lamp 10 of the present invention will appear to be suspended which is similar to the real candle light flame.

In addition, in order to prevent loss of light from the plurality of light sources 3, the surroundings of the light source 3 are painted in black color. The top area of the plurality of light sources 3 is transparent which allows the continuous line of light to propagate toward the corresponding light guide 2. In this way, the line of continuous light directly penetrates through the light guide 2 and is different from the setup of a traditional light bulb generating a point source of light with a light cover covering it.

During the operation of the candle lamp 10, the control panel 4 may adjust the magnitude and the timing of the current supplied to the plurality of light sources 3 in order to make the candle lamp flame has different color and patterns. The layer configuration of the plurality of light guides 2 and optical veins 6 may create an illusion to the human eyes that the flame is dynamic and realistic.

Operating principle: The candle lamp 10 of the present invention mimics the candle light flame appearance by using the layer configuration of the plurality of light guides 2 to create a three-dimensional structure. The bottom portion of each of the light guide 2 is directly placed on top of the light source 3. Therefore, each individual light guide 2 may be lighted on individually with different wavelengths of light provided from its respective light source 3. The control panel 4 may change the magnitude and the timing of the current supplied to the plurality of light sources 3 in order to make the candle lamp flame has different color and patterns. The control panel 4 may control the plurality of light sources 3 operation as follows: a single or multiple light sources 3 can be turned on each second while shuffling them On and Off in an pre-determined order or randomly. It should be understood that the operation of the control panel 4 is not limited to the particular setting mentioned above. The optical veins 6 are strategically placed on the display surface of the light guides 2 to conduct or to refract the light emitted from the light source 3. The optical veins 6 help to spread out the light into more directions. Combining with the different wavelengths and color temperatures, the plurality of light guides 2 can produce light with different colors and intensity. Through different layers of light produced from the plurality of light guides 2, it may create an optical illusion effect to the human eyes that the flame is realistic and dynamic. (This optical illusion effect, known as “Persistence of vision”, was first introduced by and English professor Peter Mark Roget in his research report entitled Explanation of an optical deception in the appearance of the spokes of a wheel when seen through vertical apertures. “Persistence of vision” is an optical illusion that occurs when visual perception of an object does not stop for some time even after the rays of light proceeding from the object have stopped entering human eyes.)

Comparing to the conventional candle lamps, the present invention mimics the flame appearance of a candle light by using the layer configuration of the plurality of light guides 2. Each of the light guide 2 is connected to the light source 3 capable of operating individually. In addition, this appearance may be enhanced by the combination of an engraved indentation or a protruded surface on the plurality of light guides 2. By controlling the magnitude and the timing of the current supplied to the plurality of light sources 3 through the control panel 4, a natural, realistic, color varying candle light flame appearance can be achieved. The candle lamp 10 of the present invention has simple structures which can reduces the manufacturing cost. At the same time, the design can enhance the operating efficiency and prolong the product's life.

The present invention, while illustrated and described in terms of different preferred embodiments, is not limited to the particular description contained in this specification. Additional alternative or equivalent components could also be used to practice the present invention.

What is claimed is:

1. A candle lamp, comprising:
a lamp holder having a storage compartment and an opening formed at a top portion of said lamp holder;
a power supply supported by said lamp holder in said storage compartment;
a control panel supported by said lamp holder in said storage compartment electrically connected to said power supply;
a plurality of light sources electrically connected to said control panel supported by said lamp holder in said storage compartment, each of said light sources generating a continuous line of light toward said opening; and
a plurality of light guides, each of said light guides optically communicating with said corresponding light source so that when said corresponding continuous line of light propagate toward said corresponding light guide, said continuous line of light is arranged to penetrate through said light guide and to be refracted outwardly with respect to said lamp holder for emitting a glowing light for said candle lamp.

2. The candle lamp, as recited in claim 1, wherein said plurality of light guides are being placed on top of said plurality of light sources arranged in layer configuration with respect to each other.

3. The candle lamp, as recited in claim 2, wherein said control panel may adjust the magnitude and the timing of the current supplied to said plurality of light source.

4. The candle lamp, as recited in claim 3, wherein said plurality of light guides are transparent and further comprise optical veins provided on a display surface of said light guide.

5. The candle lamp, as recited in claim 4, wherein said optical veins may be a combination of an engraved indentation or a protruded surface, wherein said engraved indentation or said protruded surface may be in strip or point shape.

6. The candle lamp, as recited in claim 5, wherein said optical veins are only provided at an upper portion and a middle portion of said display surface.

7. The candle lamp, as recited in claim 6, wherein each of said light sources may provide different wavelengths and color temperatures.

8. The candle lamp, as recited in claim 7, wherein the surroundings of said plurality of light source are painted in black color.

9. The candle lamp, as recited in claim 8, wherein said plurality of light guides are flat pieces in shape with same sizes but different cross-sectional areas, said plurality of light guides are layered horizontally next to each other.

10. The candle lamp, as recited in claim 8, wherein said plurality of light guides are flat pieces in shape with similar cross-sectional areas but are different in sizes, said plurality of light guides are layered horizontally next to each other.

11. The candle lamp, as recited in claim 8, wherein said plurality of light guides are molded in cover shape with similar cover shape but are different in sizes, said plurality of light guides are stacked onto each other concentrically from smallest to largest.

12. The candle lamp, as recited in claim 9, wherein said plurality of light sources are soldered onto said control panel.

13. The candle lamp, as recited in claim 10, wherein said plurality of light sources are soldered onto said control panel.

14. The candle lamp, as recited in claim 11, wherein said plurality of light sources are soldered onto said control panel.
